(19) United States
(12) Patent Application Publication
(10) Pub. No.: US 2020/0311859 A1
(43) Pub. Date: Oct. 1, 2020

(54) METHODS AND APPARATUS FOR IMPROVING GPU PIPELINE UTILIZATION

(71) Applicant: QUALCOMM Incorporated, San Diego, CA (US)

(72) Inventors: Yun DU, San Diego, CA (US); Nigel POOLE, West Newton, MA (US); Zilin YING, San Diego, CA (US); Ling Feng HUANG, San Diego, CA (US); Donghyun KIM, San Diego, CA (US); Chun YU, Rancho Santa Fe, CA (US); Tzun-Wei LEE, San Jose, CA (US); Xuefeng TANG, San Diego, CA (US); Shambhoo KHANDELWAL, Santa Clara, CA (US); Hongjiang SHANG, San Diego, CA (US); Elina KAMENETSKAYA, Belmont, CA (US); Zhu LIANG, San Diego, CA (US); Cary ROBINS, Newton, MA (US)

(21) Appl. No.: 16/368,782

(22) Filed: Mar. 28, 2019

(51) Int. Cl. G06T 1/20; G06F 9/48

(52) U.S. Cl. CPC G06T 1/20; G06F 9/4881

(57) ABSTRACT

The present disclosure relates to methods and apparatus for graphics processing. In some aspects, multiple processing units can be in a graphics processing pipeline of a GPU. The apparatus can also group the multiple processing units into one or more processing unit clusters. In some aspects, each of the one or more processing unit clusters can correspond to one or more context registers. Additionally, the apparatus can determine one or more context states of the one or more context registers in each of the one or more processing unit clusters. Also, the apparatus can implement one or more execution counters corresponding to at least one of the one or more processing unit clusters in the graphics processing pipeline, where each of the one or more execution counters includes an execution value.

### TECHNICAL FIELD

The present disclosure relates generally to processing systems and, more particularly, to one or more techniques for graphics processing.

### INTRODUCTION

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes one or more processing stages that operate together to execute graphics processing commands and output a frame. A central processing unit (CPU) may control the operation of the GPU by issuing one or more graphics processing commands to the GPU. Modern day CPUs are typically capable of concurrently executing multiple applications, each of which may need to utilize the GPU during execution. A device that provides content for visual presentation on a display generally includes a GPU.

Typically, a GPU of a device is configured to perform the processes in a graphics processing pipeline. However, with the advent of wireless communication and smaller, handheld devices, there has developed an increased need for improved graphics processing.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU). The apparatus can generate multiple processing units. In some aspects, the multiple processing units can be in a graphics processing pipeline of the GPU. The apparatus can also group the multiple processing units into one or more processing unit clusters. In some aspects, each of the one or more processing unit clusters can include one or more context registers. Also, the apparatus can determine one or more context states of the one or more context registers in each of the one or more processing unit clusters. The apparatus can also implement one or more execution counters in the graphics processing pipeline, where each of the one or more execution counters includes an execution value. Moreover, the apparatus can execute one or more draw call functions at each of the one or more processing unit clusters, where each of the one or more draw call functions is executed by at least one of the multiple processing units. The apparatus can also increase the execution value of one of the one or more execution counters when one of the one or more processing unit clusters starts executing one of the one or more draw call functions. Further, the apparatus can decrease the execution value of one of the one or more execution counters when one of the one or more processing unit clusters finishes executing one of the one or more draw call functions.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example GPU pipeline in accordance with one or more techniques of this disclosure.

FIG. 3 illustrates an example timing diagram of a GPU pipeline in accordance with one or more techniques of this disclosure.

FIG. 4 illustrates an example GPU pipeline in accordance with one or more techniques of this disclosure.

FIG. 5 illustrates an example timing diagram of a GPU pipeline in accordance with one or more techniques of this disclosure.

FIG. 6 illustrates an example flowchart of an example method in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

As used herein, instances of the term “content” may refer to graphical content or display content. In some examples, as used herein, the term “graphical content” may refer to a content generated by a processing unit configured to perform graphics processing. For example, the term “graphical content” may refer to content generated by one or more processes of a graphics processing pipeline. In some examples, as used herein, the term “graphical content” may refer to content generated by a graphics processing unit. In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

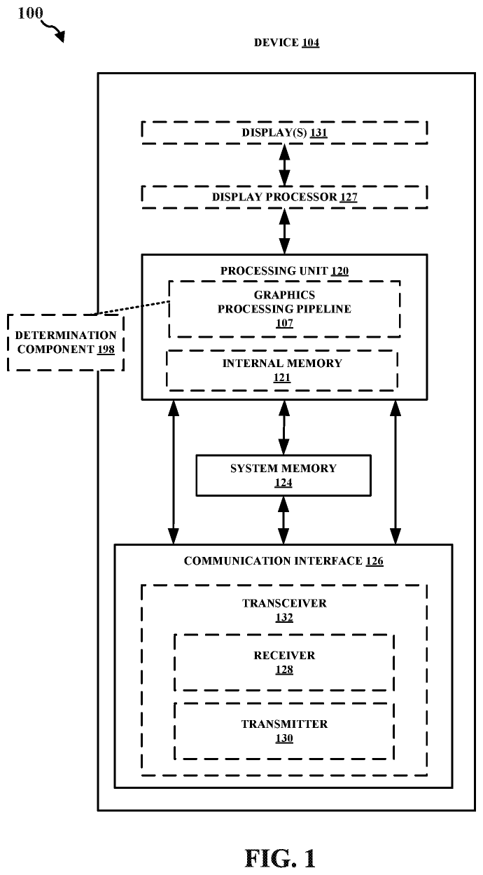

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, and a system memory 124. In some aspects, the device 104 can include a number of optional components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this can be referred to as split-rendering.

The processing unit 120 may include an internal memory 121. The processing unit 120 may be configured to perform graphics processing, such as in a graphics processing pipeline 107. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120, such as system memory 124, may be accessible to the processing unit 120. For example, the processing unit 120 may be configured to read from and/or write to external memory, such as the system memory 124. The processing unit 120 may be communicatively coupled to the system memory 124 over a bus. In some examples, the processing unit 120 may be communicatively coupled to each other over the bus or a different connection.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the graphics processing pipeline 107 may include a determination component 198 configured to generate multiple processing units. In some aspects, the multiple processing units can be in a graphics processing pipeline of the GPU. The determination component 198 can also be configured to group the multiple processing units into one or more processing unit clusters. In some aspects, each of the one or more processing unit clusters can include one or more context registers. Also, the determination component 198 can be configured to determine one or more context states of the one or more context registers in each of the one or more processing unit clusters. The determination component 198 can also be configured to implement one or more execution counters in the graphics processing pipeline, where each of the one or more execution counters includes an execution value. Moreover, the determination component 198 can be configured to execute one or more draw call functions at each of the one or more processing unit clusters, where each of the one or more draw call functions is executed by at least one of the multiple processing units. The determination component 198 can also be configured to increase the execution value of one of the one or more execution counters when one of the one or more processing unit clusters starts executing one of the one or more draw call functions. Further, the determination component 198 can be configured to decrease the execution value of one of the one or more execution counters when one of the one or more processing unit clusters finishes executing one of the one or more draw call functions.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, an augmented reality device, a virtual reality device, a display or display device, a television, a television set-top box, an intermediate network device, a digital media player, a video streaming device, a content streaming device, an in-car computer, any mobile device, any device configured to generate graphical content, or any device configured to perform one or more techniques described herein.

GPUs can process multiple types of data or data packets in a GPU pipeline. For instance, in some aspects of a GPU pipeline, the GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a Z test mode or color format. In some aspects of context register packets, there can be a bit that indicates which workload belongs to a context register. Additionally, there can be multiple functions or programming running at the same time and/or in parallel. For example, functions or programming can describe a certain operation, e.g., the color mode or color format. Accordingly, a context register can define multiple states of a GPU pipeline.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs and GPU pipelines can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. In addition, the workload that corresponds to the mode or state may follow the changing mode or state.

In some aspects, a GPU can utilize a command processor (CP) or hardware accelerator to parse a command buffer into context register packets and/or draw call data packets. The CP can then send the context register packets or draw call data packets through separate paths to the processing units or blocks in the GPU. Additionally, the command buffer can alternate different states of context registers and draw calls. For example, a command buffer can be structured as follows: context register of context N, draw call(s) of context N, context register of context N+1, and draw call(s) of context N+1.

In some aspects, for each GPU processing unit or block, a context register may need to be prepared before any draw call data can be processed. As context registers and draw calls can be serialized, e.g., because they can be within the same command buffer, it can be helpful to have an extra context register prepared before the next draw call. In some instances, draw calls of the next context can be fed through the GPU data pipeline in order to hide context register programming latency. Further, when a GPU is equipped with multiple sets of context registers, each processing unit can have sufficient context switching capacity to manage smooth context processing. In turn, this can enable the GPU to cover pipeline latency that can result from unpredictable memory access latency and/or extended processing pipeline latency.

In some instances, GPUs with a dual set of context registers may experience some processing delays. For example, contexts with small payloads may result in delays, as well as continuous drops in transition payload between GPU blocks. This can also cause downstream block starving, i.e., a burst of dead draw calls or a burst of pixel drops. In turn, this can result in upstream blocks performing much of the workload, while downstream blocks do not perform much workload. Furthermore, for GPUs with a binning architecture, a smaller global memory (GMEM) size may be desired in order to save costs and provide efficient memory access. However, this can cause the context payload to be reduced to even smaller amounts and make the aforementioned problems more severe. As a result, there may be a reduction in the utilization of more expensive resources, e.g., streaming processors (SPs) or arithmetic logic units (ALU).

As mentioned above, in a GPU pipeline, there can be two parallel workflows, e.g., context register data and draw call data. In some aspects, a context register can indicate multiple states, e.g., a state of zero or one. When a GPU has a certain workload to be performed, a workload identification (ID) can be utilized to match the state ID. For example, a vertex processing workload can use a workload ID of zero, which can match a context ID of zero. Accordingly, GPUs can have a one-to-one ID matching between the workload ID and the context ID. In some instances, the GPU pipeline workload can be handled by a few context registers. For example, the entire GPU pipeline can be handled by two sets of context registers. In these instances, some workloads may use one context state, while other workloads may use another context state. For example, a VFD workload may use a context state of one, while a render backend (RB) workload may use a context state of zero. As such, in some aspects, the difference between the first and last context states may be a single context state, e.g., if the available context states are one and zero. In some aspects, even if a certain workload is small, the workload may still have to go through the entire GPU pipeline. In these aspects, when there are two context states available, delays or wasted cycles may be experienced.

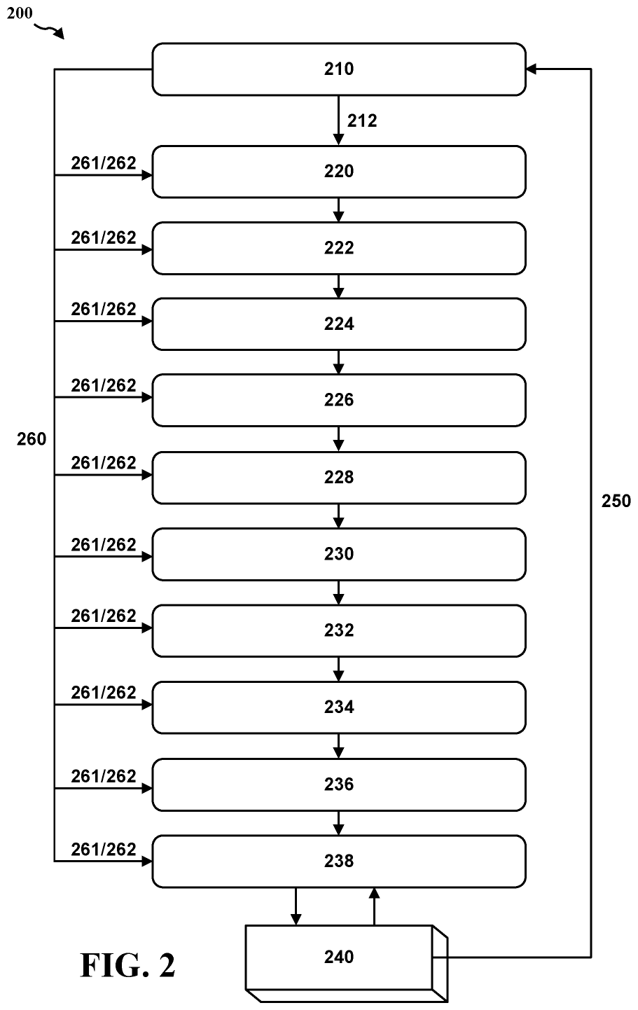

FIG. 2 illustrates an example GPU pipeline 200 in accordance with one or more techniques of this disclosure. More specifically, FIG. 2 displays that GPU pipeline 200 is a pipeline that includes dual context processing. As shown in FIG. 2, GPU pipeline 200 includes CP 210, draw call packet 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, RB 236, L2 cache (UCHE) 238, and system memory 240. Although FIG. 2 displays that GPU pipeline 200 includes processing units 220-238, GPU pipeline 200 can include a number of additional processing units. Also, processing units 220-238 are merely an example and any combination or order of processing units can be used by GPUs according to the present disclosure. GPU pipeline 200 also includes command buffer 250, context register packet 260, and context states 261, 262.

As shown in FIG. 2, the GPU pipeline 200 processes two different types of data packets, e.g., context register packet 260 and draw call packet 212. As mentioned above, the workload for an entire GPU pipeline can be handled by a few context registers. FIG. 2 shows that GPU pipeline 200 includes two sets of context registers with two context states, e.g., context states 261, 262. As there are two sets of context registers in GPU pipeline 200, two workloads can be performed at the same time. In some aspects, separate workloads may be assigned to different context states. For example, one workload may be assigned a context state of zero, while another workload may be assigned a context state of one. As displayed in FIG. 2, GPU pipeline 200 includes a number of different processing units or blocks, e.g., processing units 220-238. As each workload may be processed by each processing unit, it can take some time for a workload to process through the entire GPU pipeline. Further, because there are two sets of context registers, there may be different processing units that are processing different workloads at the same time. For example, VFD 220 may be processing a workload with a context state of one, while RB 236 may be processing a workload with a context state of zero.

In some aspects, even if a workload is relatively small, the workload may still have to progress through each processing unit in the entire pipeline, e.g., CP 210 to UCHE 238. Further, each processing unit may need some time to process the workload request, no matter how small the workload. As a result, there can be a large latency from when a workload starts at the first processing unit, e.g., VFD 220, until it reaches the last processing unit, e.g., UCHE 238. Accordingly, in some instances, if a workload is small, and the GPU pipeline is long, there can be latency issues, such as inefficient utilization of processing units or wasted cycles.

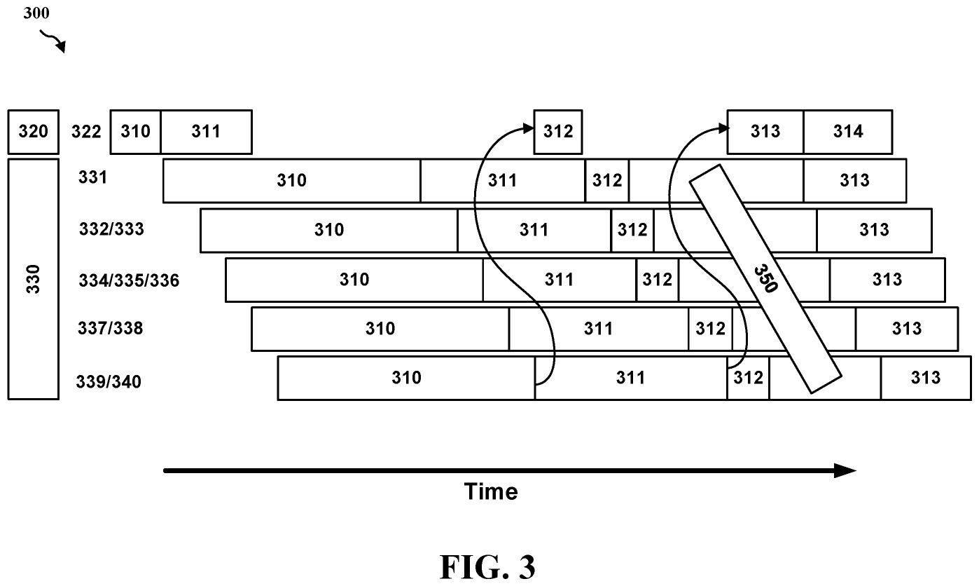

FIG. 3 illustrates an example timing diagram 300 of a GPU pipeline in accordance with one or more techniques of this disclosure. More specifically, FIG. 3 displays that the GPU pipeline includes a dual context. The GPU pipeline includes workloads 310-314, programming portion 320, CP 322, execution portion 330, VFD 331, VS 332, VPC 333, TSE 334, RAS 335, ZPE 336, PI 337, FS 338, RB 339, UCHE 340, and empty cycles 350. As shown in FIG. 3, the workloads 310-314 can process through the GPU pipeline from CP 322 through UCHE 340. CP 322 is in the programming portion 320 of the GPU pipeline, as it performs the programming for the workloads 310-314. Once the programming is performed, the workloads 310-314 can process through the execution portion 330 of the pipeline, e.g., VFD 331 through UCHE 340. In some aspects, workloads 310-314 can be referred to as draw call functions 310-314.

FIG. 3 displays that there may be two context states in the GPU pipeline. For instance, the GPU pipeline can process two workloads, e.g., workload 310 and 311, at the same time. In some aspects, workloads 310-314 may be referred to as context states 310-314. As indicated above, CP 322 processes the programming states, while VFD 331 through UCHE 340 process the execution states. In some aspects, when a workload is large, e.g., a draw call that is large compared to other draw calls, there may not be many wasted or empty cycles, i.e., an amount of time a processing unit 331-340 does not spend processing a workload. FIG. 3 shows that workloads 310 and 311 are relatively large compared to workloads 311 and 312.

As shown in FIG. 3, CP 322 may finish programming a workload or particular context state before VFD 331 can start executing the workload. For example, VFD 331 does not start executing workload 310 until CP 322 finishes programming workload 310. As further shown in FIG. 3, processing units 331-340 may take a longer amount of time to execute a particular workload compared to CP 322. For example, CP 322 programs workload 310 in a shorter amount of time than it takes processing units 331-340 to execute workload 310. Additionally, the delay between each processing unit 331-340 can be part of a delay processing cycle. For example, when rendering a certain shape, e.g., a triangle or primitive, the GPU pipeline can fetch a vertex using the VFD 331, which may result in a particular latency. Once the vertex is fetched, the data can be sent to the VS 332 and VPC 333 blocks, where the vertex can be transformed. After the vertex transformation, the vertex can be sent to the TSE 334, RAS 335, and ZPE 336. As such, there can be a delay in the processing of different processing units 331-340.

As shown in FIG. 3, there are two sets of context registers that can process two different workloads or context states at a time, so there may be two contexts in the GPU pipeline at a time. Thus, in order to start the programming for a third workload, one of the two workloads may finish executing. For example, in order to start the programming for workload 312, the present disclosure may wait for workload 310 to finish executing. Accordingly, the GPU can overwrite workload 310 with workload 312, so the GPU may wait for the execution cycle of workload 310 to finish before programming and executing workload 312.

In some aspects, the processing cycles for each workload may not be equal. For example, the execution time of workloads 310 and 311 may not be equal to the execution time of workload 312. As shown in FIG. 3, because workload 312 is small compared to workloads 310 and 311, e.g., workload 312 represents a draw call that is small compared to other draw calls, there can be a large latency in the processing cycle and result in empty cycles 350. This can be especially true if the GPU pipeline is long, e.g., the GPU pipeline includes 10 or more processing units, as all the different GPU blocks may need to finish processing the first workload, e.g., workload 310, before a third workload, e.g., workload 312, can begin programming and executing. Additionally, in some aspects, a workload execution time may increase for different processing units, e.g., if the GPU is rendering a very large triangle or primitive. In this case, the workload for some processing units, e.g., ZPE 336 to FS 338, may take a longer time compared to other processing units. As such, in some instances, certain processing units may take more time to execute a certain workload or context state.

As mentioned above, context states with small workloads or payloads may still take a long time to flush through the pipeline. Even in cases where the programming takes little time, a CP, e.g., CP 322, may wait for the payload to flush through the pipeline, which can cause significant overhead. As long as a payload execution is smaller than a pipeline depth, latency issues can occur, such as delays or inefficient use of processing units. Generally, if more contexts can be allowed to run in parallel in a GPU pipeline, i.e., more than two contexts or workloads at the same time, it can help the GPU pipeline achieve a higher utilization. In turn, this can improve the overall GPU performance. However, increasing the amount of context registers may not be cost efficient, as the costs associated with each context register are high. For instance, the amount of context registers can be increased, e.g., to 4, 8, or 16, but it will increase the costs associated with running the GPU pipeline. Further, as mentioned herein, the processing time for certain blocks, e.g., VFD 331 through ZPE 336, may take a long time compared to other blocks, so some other blocks, e.g., PI 337 through UCHE 340, may not be performing any work at this time.

In order to solve the aforementioned latency issues caused by using two sets of context registers, the present disclosure can group or separate the processing units or blocks, e.g., into processing unit clusters. By doing so, GPU pipelines according to the present disclosure can perform workloads at different processing unit clusters in parallel at the same time. For example, instead of performing workloads within a GPU pipeline in series, as in FIG. 2 above, the present disclosure can group processing units or blocks into clusters and perform the workloads in parallel at each group of processing units.

In some aspects, the present disclosure can utilize multiple context registers with each of the processing unit clusters at the same time. Therefore, the multiple context registers at each of the processing unit clusters can process multiple workloads at the same time. Accordingly, the present disclosure can process more workloads at the same time, which allows the present disclosure to process workloads more efficiently, as well as maintain the costs associated with a GPU pipeline. In some instances, the number of workloads the present disclosure can process at one time may be equal to the number of processing unit clusters multiplied by the number of context registers in each processing unit cluster. For example, if the processing units are divided into five different processing unit clusters, and there are two sets of context registers associated with each cluster, then the present disclosure can process ten workloads at the same time.

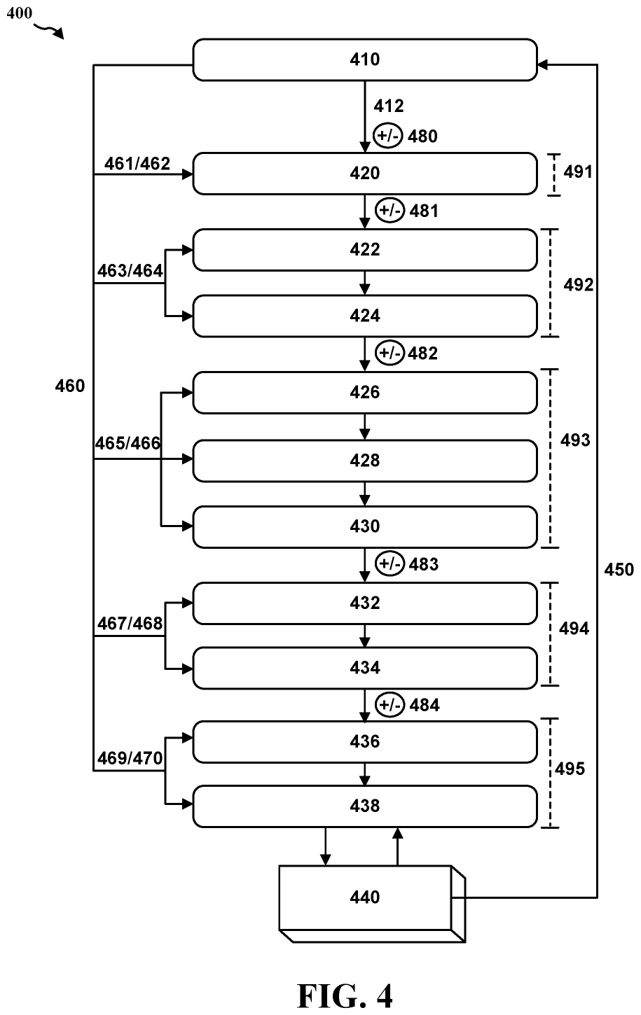

FIG. 4 illustrates an example GPU pipeline 400 in accordance with one or more techniques of this disclosure. FIG. 4 also illustrates that GPU pipeline 400 includes dual context processing. As shown in FIG. 4, GPU pipeline 400 includes CP 410, draw call packet 412, VFD 420, VS 422, VPC 424, TSE 426, RAS 428, ZPE 430, PI 432, FS 434, RB 436, UCHE 438, and system memory 440. Although FIG. 4 displays that GPU pipeline 400 includes processing units 420-438, GPU pipeline 400 can include a number of additional processing units. Also, processing units 420-438 are merely an example and any combination or order of processing units can be used by GPUs according to the present disclosure. GPU pipeline 400 also includes command buffer 450, context register packet 460, and context states 461-470. As shown in FIG. 4, the GPU pipeline 400 processes two different types of data packets, e.g., context register packet 460 and draw call packet 412. GPU pipeline 400 can also include execution counters 480-484.

As shown in FIG. 4, processing units 420-438 can be grouped into processing unit clusters 491-495. GPU pipeline 400 can also include two sets of context registers, where the two sets of context registers can be assigned to each of the processing unit clusters 491-495. As two sets of context registers can be assigned to each processing unit cluster, each of the processing unit clusters 491-495 can include two context states. For example, processing unit cluster 491 includes context states 461 and 462, processing unit cluster 492 includes context states 463 and 464, processing unit cluster 493 includes context states 465 and 466, processing unit cluster 494 includes context states 467 and 468, and processing unit cluster 495 includes context states 469 and 470. Therefore, the number of context states, e.g., ten, can be equal to the number of context registers, e.g., two, multiplied by the number of processing unit clusters, e.g., five. As there are ten different context states in GPU pipeline 400, ten different workloads can be processed at the same time. Accordingly, the processing unit clusters 491-495 can operate in parallel at the same time.

As shown in FIG. 4, processing unit cluster 491 includes VFD 420, processing unit cluster 492 includes VS 422 and VPC 424, processing unit cluster 493 includes TSE 426, RAS 428, and ZPE 430, processing unit cluster 494 includes PI 432 and FS 434, and processing unit cluster 495 includes RB 436 and UCHE 438. As mentioned above, the amount of context registers in the GPU pipeline 400, e.g., two, can be assigned to each processing unit cluster 491-495. Accordingly, the present disclosure may use two sets of context registers, but by grouping the processing units or blocks into clusters 491-495, the present disclosure effectively multiplies the number of context states by the number of processing unit clusters. As indicated above, the two sets of context registers in GPU pipeline 400 can result in ten different context states 461-470, based on the five different processing unit clusters 491-495. By grouping the processing units into clusters, the cost of supporting ten different context states with two sets of context registers can still be close to the cost of supporting two different context states with two sets of context registers. Thus, the present disclosure can reduce the granularity in the GPU pipeline while maintaining similar operating costs. In some aspects, the cost to operate the CP 410 may increase, as it may keep track of all the different context states 461-470, but the cost to operate processing units 420-438 may remain approximately the same. For example, the data in the context registers processed by the CP 410 can be included in the RAM, which can be relatively inexpensive. By doing so, the GPU pipeline 400 can process the context states 461-470 relatively cheaply and in parallel.

In some aspects of the present disclosure, there may be no limit to the number of processing unit clusters or groups. As mentioned above, there may be a small cost associated with the amount of cluster groups, however, these costs are minor compared to increasing the number of context registers. In some aspects, the present disclosure can group the processing units into clusters according to the workload boundaries of the GPU pipeline. This is similar to how the processing units 420-438 in FIG. 4 are grouped into the processing unit clusters 491-495. In some aspects, the present disclosure can group a single processing unit into a cluster, but it may not be necessary, as each processing task has workload boundaries that can include multiple processing units. In some aspects, the GPU pipeline 400 can organize the cluster boundaries such that each processing unit or block can process a workload independently from one another. If the clusters were organized in another fashion, then the processing units may have to wait for another processing unit to finish before starting the processing, which would negate the purpose of clustering.

GPU pipeline 400 can also implement a number of execution counters or switches 480-484 that can count the number of workloads or context register packets per processing unit cluster. For example, these execution counters or switches 480-484 can act as a gate keeper logic function for each of the processing unit clusters 491-495. In some aspects, the execution counters 480-484 can be before or adjacent to the processing unit clusters 491-495. Accordingly, the number of execution counters 480-484 can be equal to the number of processing unit clusters 491-495. In some instances, the execution counters 480-484 can limit the amount of workloads or context states within each processing unit cluster 491-495 to two workloads or context states. For example, the execution counters 480-484 can limit adding workloads or context states until the amount of workloads or context states decreases to less than two. The execution counters 480-484 can each include an execution value, which can keep track of the number of workloads or context states within each processing unit cluster 491-495.

In some aspects, GPU pipeline 400 can include a programming end (prog_end) function for each processing unit cluster 491-495 that can record when the context programming is finished. For example, once the programming is finished for a workload, and the execution for the workload is started, an execution counter can increase its execution value by one. Once the execution or workload processing is finished, a draw call end (drawcall_end) function can decrease the execution value by one. In some aspects, the CP 410 can prevent any additional context register packet programming from being processed until the execution value of the execution counter is less than the number of context states per cluster, e.g., two. If the execution value is less than the number of context states per cluster, e.g., two, the CP 410 can accept a draw call packet and process it. As such, the present disclosure can keep track of how many workloads or contexts are being programmed or executed, which can be limited to the number of context states in a processing unit cluster. For example, when the execution value of an execution counter is zero or one, the present disclosure can have room for additional workload programming or execution. Accordingly, the execution counters 480-484 can be a gate keeper for programming or execution workload.

In some aspects, the number of processing unit clusters can be equal to the number of execution counters in GPU pipeline 400. For example, as shown in FIG. 4, there can be five processing unit clusters and five execution counters. In these instances, the execution counters may be located before or adjacent to each processing unit cluster. In some aspects, the execution counters can be located near the top of the GPU pipeline, e.g., above the CP 410, and start counting before the GPU pipeline 400 programs the contexts at the CP 410. In further aspects, there can be one execution counter that keeps track of all the workloads or context states for each processing unit cluster.

As shown in FIG. 4, the present disclosure can generate multiple processing units, e.g., processing units 420-438, which can be in GPU pipeline 400 of a GPU. The present disclosure can also group the multiple processing units, e.g., processing units 420-438, into processing unit clusters, e.g., processing unit clusters 491-495. As mentioned above, each of the processing unit clusters 491-495 can include one or more sets of context registers, e.g., two sets of context registers. The present disclosure can also determine one or more context states, e.g., context states 461-470, of the context registers in each of the processing unit clusters 491-495. As shown in FIG. 4, the present disclosure can also implement one or more execution counters, e.g., execution counters 480-484, in the GPU pipeline 400. In some aspects, each of the execution counters 480-484 can include an execution value.

In some aspects, the number of execution counters 480-484 can be equal to the number of processing unit clusters 491-495. Also, the number of context registers in each of the processing unit clusters 491-495 can be two. In further aspects, the number of context states 461-470, e.g., ten, can be equal to the number of context registers, e.g., two, multiplied by the number of processing unit clusters 491-495, e.g., five. As shown in FIG. 4, the GPU pipeline 400 can include both CP 410 and system memory 440. In further aspects, the CP 410 can be in a programming portion of the GPU pipeline 400, and the processing units 420-438 can be in an execution portion of the GPU pipeline 400.

As mentioned above, CP 410 can generate a prog_end function and feed it through a programming path at the end of the context register, as well as generate a drawcall_end function and feed it through a draw call packet path at the end of draw call, e.g., as a pair per context packet or state. In some aspects, this can ensure robust synchronization between a draw call packet path and a context register packet path, as well as finer grain context handling among GPU blocks or processing units. As mentioned above, the present disclosure can also split the GPU blocks or processing units into multiple clusters, where the processing units can form a cluster based on workload boundaries to allow for a maximum amount of contexts in the GPU pipeline 400. Each processing unit cluster can manage a context register packet and a draw call packet for two workloads or context states. Also, each processing unit cluster can run a different workload or context state. For instance, cluster boundaries can be set when data packet transition can be increased or decreased, e.g., ZPE 430 can increase or decrease pixels based on a Z comparison.

As mentioned previously, each processing unit cluster can include a gate keeper logic function or execution counter that can increase based on a prog_end function acknowledgement and/or decrease based on a drawcall_end function acknowledgement. In some aspects, if an execution value of the execution counter equals zero, then the cluster can prevent any draw call packet transition from entering the upper stream of the GPU pipeline 400. Also, if the execution counter equals two, then the CP 410 can prevent any additional context register packet programming until the execution counter decreases to less than two. Otherwise, the GPU pipeline 400 can accept the next draw call packet and process. In one aspect, as an example of efficient implementation, the CP 410 can have a single shared memory pool to hold multiple context register packets, e.g., as long as the memory pool has available space. In further aspects, the memory pool can manage a ringer buffer with multiple read or write pointers per processing unit cluster. As mentioned herein, the CP 410 can process more context register packets in advance of draw call packet execution. By doing so, the present disclosure can provide faster programming cycles and/or pipeline cycles for each processing unit cluster.

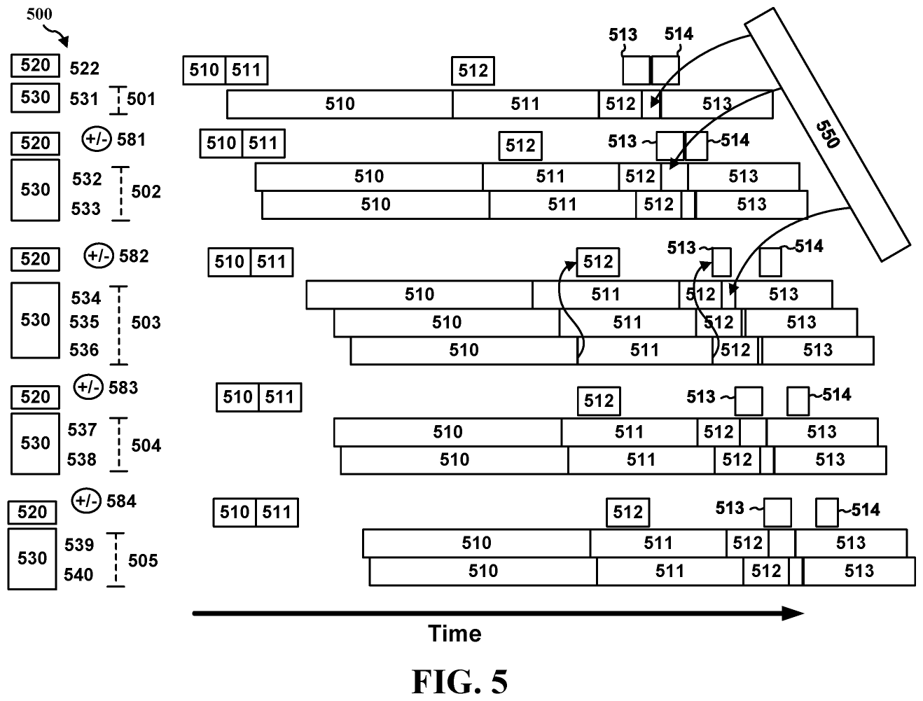

FIG. 5 illustrates an example timing diagram 500 of a GPU pipeline in accordance with one or more techniques of this disclosure. As shown in FIG. 5, the GPU pipeline includes workloads 510-514, programming portion 520, CP 522, execution portion 530, VFD 531, VS 532, VPC 533, TSE 534, RAS 535, ZPE 536, PI 537, FS 538, RB 539, UCHE 540, and empty cycles 550. Also, the GPU pipeline can include execution counters 581-584. As shown in FIG. 5, CP 522 can be in the programming portion 520 of the GPU pipeline, while VFD 531, VS 532, VPC 533, TSE 534, RAS 535, ZPE 536, PI 537, FS 538, RB 539, and UCHE 540 can be in the execution portion 530 of the GPU pipeline. Once the programming is performed for a workload 510-514 at the programming portion 520, the workloads 510-514 can process through the execution portion 530 of the pipeline, e.g., VFD 531 through UCHE 540. In some aspects, workloads 510-514 can be referred to as draw call functions 510-514.

As shown in FIG. 5, the GPU pipeline also includes processing unit clusters 501-505. Processing unit cluster 501 can include VFD 531, processing unit cluster 502 can include VS 532 and VPC 533, processing unit cluster 503 can include TSE 534, RAS 535, and ZPE 536, processing unit cluster 504 can include PI 537 and FS 538, and processing unit cluster 505 can include RB 539 and UCHE 540. As in GPU pipeline 400, there can be two sets of context registers in the GPU pipeline in FIG. 5. By grouping the processing units 531-540 into processing unit clusters 501-505, the GPU pipeline can operate as if there are ten context states for ten workloads. For instance, each processing unit cluster 501-505 can process two workloads 510-514 at the same time. By doing so, the GPU pipeline can minimize empty or wasted cycles 550 and improve its utilization and efficiency. This can be especially true during shorter workloads, e.g., workload 512, such that the empty cycles 550 are minimized at each processing unit cluster 501-505.

In some aspects, the GPU pipeline in FIG. 5 can execute one or more draw call functions, e.g., draw call functions 510-514, at each of the processing unit clusters 501-505. For example, two draw call functions can be executed at the same time at each of processing unit clusters 501-505. As further shown in FIG. 5, each of the draw call functions 510-514 can be executed by each of the processing unit clusters 501-505. The GPU pipeline in FIG. 5 can also increase the execution value of an execution counter, e.g., execution counters 581-584, when one of the processing unit clusters 501-505 starts executing one of the draw call functions 510-514. The GPU pipeline in FIG. 5 can also decrease the execution value of one of the execution counters 581-584 when one of the processing unit clusters 501-505 finishes executing one of the draw call functions 510-514. Additionally, each of the draw call functions 510-514 can correspond to a context state or workload.

FIG. 5 illustrates the improved efficiency of the GPU pipeline, e.g., as a result of grouping the processing units 531-540 into processing unit clusters 501-505. For instance, by grouping the processing units 531-540 into processing unit clusters 501-505, the GPU pipeline can reduce or minimize the empty cycles 550 for each processing unit 531-540. In some aspects, as shown in FIG. 5, the processing or execution time for each workload or draw call function 510-514 can be the same in each processing unit cluster 501-505. For example, FIG. 5 shows that processing time for workloads 510-514 can be the same at each processing unit cluster 501-505.

As mentioned above, the present disclosure can extend the dual context scheme for GPU pipelines, such as by having a finer grain dual context for multiple processing unit clusters 501-505. Additionally, by extending the dual context scheme for the entire GPU pipeline to a finer grain dual context for multiple processing unit clusters, the present disclosure can enable the execution of more contexts with little added cost. In some aspects, the present disclosure can be applied to context schemes that are different from dual context schemes, e.g., context schemes that include three or more context registers. The present disclosure can also improve the utilization and/or resource efficiency of processing units in a GPU pipeline.

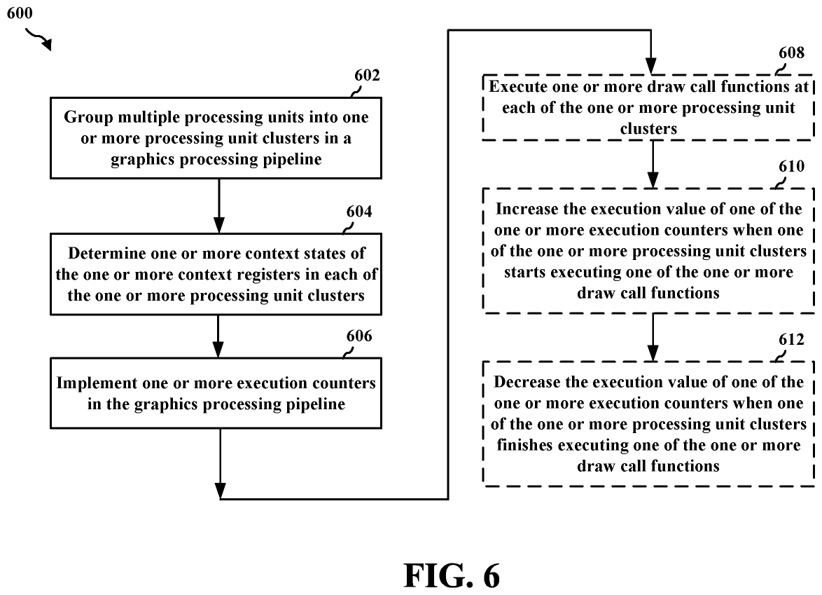

FIG. 6 illustrates an example flowchart 600 of an example method in accordance with one or more techniques of this disclosure. The method may be performed by a GPU or apparatus for graphics processing. In some aspects, multiple processing units can be in a graphics processing pipeline of a GPU, as described in connection with the examples in FIGS. 4 and 5. At 602, the apparatus can group the multiple processing units into one or more processing unit clusters, as described in connection with the examples in FIGS. 4 and 5. In some instances, each of the one or more processing unit clusters can correspond to one or more context registers, as described in connection with the examples in FIGS. 4 and 5. At 604, the apparatus can determine one or more context states of the one or more context registers in each of the one or more processing unit clusters, as described in connection with the examples in FIGS. 4 and 5. At 606, the apparatus can also implement one or more execution counters corresponding to at least one of the one or more processing unit clusters in the graphics processing pipeline, as described in connection with the examples in FIGS. 4 and 5. In some aspects, each of the one or more execution counters can include an execution value, as described in connection with the examples in FIGS. 4 and 5.

At 608, the apparatus can execute one or more draw call functions at each of the one or more processing unit clusters, as described in connection with the examples in FIGS. 4 and 5. In some aspects, each of the one or more draw call functions is executed by at least one of the multiple processing units, as described in connection with the examples in FIGS. 4 and 5. At 610, the apparatus can also increase the execution value of one of the one or more execution counters when one of the one or more processing unit clusters starts executing one of the one or more draw call functions, as described in connection with the examples in FIGS. 4 and 5. At 612, the apparatus can decrease the execution value of one of the one or more execution counters when one of the one or more processing unit clusters finishes executing one of the one or more draw call functions, as described in connection with the examples in FIGS. 4 and 5. Additionally, each of the one or more draw call functions can correspond to one of the one or more context states, as described in connection with the examples in FIGS. 4 and 5.

In some aspects, a number of the one or more execution counters can be equal to a number of the one or more processing unit clusters, as described in connection with the examples in FIGS. 4 and 5. Also, a number of the one or more context registers in each of the one or more processing unit clusters can be two, as described in connection with the examples in FIGS. 4 and 5. In further aspects, a number of the one or more context states can be equal to a number of the one or more context registers multiplied by a number of the one or more processing unit clusters, as described in connection with the examples in FIGS. 4 and 5.

In some aspects, the graphics processing pipeline can include a command processor and a system memory, as described in connection with the examples in FIGS. 4 and 5. In further aspects, the command processor can be in a programming portion of the graphics processing pipeline, as described in connection with the examples in FIGS. 4 and 5. Moreover, the multiple processing units can be in an execution portion of the graphics processing pipeline, as described in connection with the examples in FIGS. 4 and 5. In some aspects, the multiple processing units can include at least one of a VFD, a VS, a VPC, a TSE, a RAS, a ZPE, a PI, a FS, a RB, or a UCHE, as described in connection with the examples in FIGS. 4 and 5. In some aspects, the apparatus can be a wireless communication device.

In one configuration, a method or apparatus for graphics processing is provided. The apparatus may be a GPU or some other processor that can perform graphics processing. In one aspect, the apparatus may be the processing unit 120 within the device 104, or may be some other hardware within device 104 or another device. The apparatus may include means for generating multiple processing units, where the multiple processing units are in a graphics processing pipeline of the GPU. The apparatus may also include means for grouping the multiple processing units into one or more processing unit clusters, where each of the one or more processing unit clusters includes one or more context registers. Also, the apparatus may include means for determining one or more context states of the one or more context registers in each of the one or more processing unit clusters. The apparatus may also include means for implementing one or more execution counters in the graphics processing pipeline, wherein each of the one or more execution counters includes an execution value. Additionally, the apparatus can include means for executing one or more draw call functions at each of the one or more processing unit clusters, where each of the one or more draw call functions is executed by at least one of the multiple processing units. The apparatus can also include means for increasing the execution value of one of the one or more execution counters when one of the one or more processing unit clusters starts executing one of the one or more draw call functions. Moreover, the apparatus can include means for decreasing the execution value of one of the one or more execution counters when one of the one or more processing unit clusters finishes executing one of the one or more draw call functions.

The subject matter described herein can be implemented to realize one or more benefits or advantages. For instance, the described graphics processing techniques can be used by GPUs or other graphics processors to enable more data or context execution within the GPU pipeline. This can also be accomplished at a low cost compared to other graphics processing techniques. Additionally, the graphics processing techniques herein can improve or speed up data processing or execution. Further, the graphics processing techniques herein can improve a GPU's resource or data utilization and resource efficiency.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

1. A method for graphics processing, comprising:
grouping a plurality of processing units in a graphics processing pipeline into one or more processing unit clusters that operate in parallel in the graphics processing pipeline, wherein each of the one or more processing unit clusters corresponds to one or more context registers;
determining one or more context states of the one or more context registers in each of the one or more processing unit clusters; and
implementing one or more execution counters corresponding to at least one of the one or more processing unit clusters in the graphics processing pipeline, wherein each of the one or more execution counters includes an execution value.

2. The method of claim 1, further comprising:
executing one or more draw call functions at each of the one or more processing unit clusters, wherein each of the one or more draw call functions is executed by at least one of the plurality of processing units.

3. The method of claim 2, further comprising:
increasing the execution value of one of the one or more execution counters when one of the one or more processing unit clusters starts executing one of the one or more draw call functions.

4. The method of claim 2, further comprising:
decreasing the execution value of one of the one or more execution counters when one of the one or more processing unit clusters finishes executing one of the one or more draw call functions.

5. The method of claim 2, wherein each of the one or more draw call functions corresponds to one of the one or more context states.

6. The method of claim 1, wherein a number of the one or more execution counters is equal to a number of the one or more processing unit clusters.

7. The method of claim 1, wherein a number of the one or more context registers in each of the one or more processing unit clusters is two.

8. The method of claim 1, wherein a number of the one or more context states is equal to a number of the one or more context registers multiplied by a number of the one or more processing unit clusters.

9. The method of claim 1, wherein the graphics processing pipeline includes a command processor and a system memory, wherein the command processor is in a programming portion of the graphics processing pipeline, wherein the plurality of processing units are in an execution portion of the graphics processing pipeline.

10. The method of claim 1, wherein the graphics processing pipeline is in a graphics processing unit (GPU).

11. The method of claim 1, wherein the plurality of processing units includes at least one of a vertex fetcher (VFD), a vertex shader (VS), a vertex cache (VPC), a triangle setup engine (TSE), a rasterizer (RAS), a Z process engine (ZPE), a pixel interpolator (PI), a fragment shader (FS), a render backend (RB), or an L2 cache (UCHE).

12. An apparatus for graphics processing, comprising:
a memory; and
at least one processor coupled to the memory and configured to:
group a plurality of processing units in a graphics processing pipeline into one or more processing unit clusters that operate in parallel in the graphics processing pipeline, wherein each of the one or more processing unit clusters corresponds to one or more context registers;
determine one or more context states of the one or more context registers in each of the one or more processing unit clusters; and
implement one or more execution counters corresponding to at least one of the one or more processing unit clusters in the graphics processing pipeline, wherein each of the one or more execution counters includes an execution value.

13. The apparatus of claim 12, wherein the at least one processor is further configured to:
execute one or more draw call functions at each of the one or more processing unit clusters, wherein each of the one or more draw call functions is executed by at least one of the plurality of processing units.

14. The apparatus of claim 13, wherein the at least one processor is further configured to:
increase the execution value of one of the one or more execution counters when one of the one or more processing unit clusters starts executing one of the one or more draw call functions.

15. The apparatus of claim 13, wherein the at least one processor is further configured to:
decrease the execution value of one of the one or more execution counters when one of the one or more processing unit clusters finishes executing one of the one or more draw call functions.

16. The apparatus of claim 13, wherein each of the one or more draw call functions corresponds to one of the one or more context states.

17. The apparatus of claim 12, wherein a number of the one or more execution counters is equal to a number of the one or more processing unit clusters.

18. The apparatus of claim 12, wherein a number of the one or more context registers in each of the one or more processing unit clusters is two.

19. The apparatus of claim 12, wherein a number of the one or more context states is equal to a number of the one or more context registers multiplied by a number of the one or more processing unit clusters.

20. The apparatus of claim 12, wherein the graphics processing pipeline includes a command processor and a system memory, wherein the command processor is in a programming portion of the graphics processing pipeline, wherein the plurality of processing units are in an execution portion of the graphics processing pipeline.

21. The apparatus of claim 12, wherein the graphics processing pipeline is in a graphics processing unit (GPU).

22. The apparatus of claim 12, wherein the plurality of processing units includes at least one of a vertex fetcher (VFD), a vertex shader (VS), a vertex cache (VPC), a triangle setup engine (TSE), a rasterizer (RAS), a Z process engine (ZPE), a pixel interpolator (PI), a fragment shader (FS), a render backend (RB), or an L2 cache (UCHE).

23. The apparatus of claim 12, wherein the apparatus is a wireless communication device.

24. A non-transitory computer-readable medium storing computer executable code for graphics processing, comprising code to:
group a plurality of processing units in a graphics processing pipeline into one or more processing unit clusters that operate in parallel in the graphics processing pipeline, wherein each of the one or more processing unit clusters corresponds to one or more context registers;
determine one or more context states of the one or more context registers in each of the one or more processing unit clusters; and
implement one or more execution counters corresponding to at least one of the one or more processing unit clusters in the graphics processing pipeline, wherein each of the one or more execution counters includes an execution value.
